(19) United States
(12) Patent Application Publication
(10) Pub. No.: US 2003/0224782 A1
(43) Pub. Date: Dec. 4, 2003

(54) Method and system of connecting broadband wireless systems to wireline serving area interfaces

(76) Inventor: Angus O. Dougherty, Westminster, CO (US)

Correspondence Address: Angus O. Dougherty, 11281 Ranch Place, Westminster, CO, 80234, US

(21) Appl. No.: 10/364,603

(22) Filed: Feb. 11, 2003

Related U.S. Application Data
(63) Continuation-in-part of application No. 10/244,698, filed on Sep. 16, 2002.
(60) Provisional application No. 60/355,202, filed on Feb. 11, 2002.

(51) Int. Cl. H04Q 7/20

(52) U.S. Cl. 455/426.2; 455/445

(57) ABSTRACT

Interconnecting broadband wireless with local telephone serving area interfaces provide an ability to establish a broadband communication system that delivers high speed Internet access over customer telephone lines unable to get such access through traditional telephone company systems. The present invention discloses how to interconnect a wireless-enabled terminal node to the telephone company serving area interface. How wireless terminal nodes are linked to the Internet using a plurality of microwave relays providing access, distribution and transport, as well as interconnect to the Internet. The terminal node provides Internet access to a variety of devises, including computers, computer networks, personal digital assistance, Internet appliances, telecommunications handsets, entertainment equipment and any other device serving as an information source and sink that is connected to the customer's home or office by two wire twisted copper pair or similar connections with a differing number of wires.

In accordance with the present invention, a wireless terminal node is provided. The wireless terminal node permits rapid, scalable, and inexpensive growth of broadband Internet access to communities otherwise unable to be served due to limitations within the outside telecommunications feeder cables and transmission system.

### CROSS-REFERENCE TO RELATED APPLICTIONS

This application claims the benefit of a U.S. Provisional Patent Application filed Sep. 15, 2001, titled “Method and System of Interconnecting Broadband Wireless Transport Systems to Telephone Service Wires at a Feeder/Distribution Interface,” U.S. Provisional Application No. 60/355,202, filed Feb. 11, 2002, titled “Method and System of Interconnecting Broadband Wireless Transport Systems to Telephone Service Wires at a Feeder/Distribution Interface,” and is a continuation-in-part of copending U.S. patent application Ser. No. 10/244,698 filed Sep. 16, 2002, titled “Method and System of Interconnecting Broadband Wireless Transport Systems to Telephone Service Wires at a Feeder/Distribution Interface,” each of which are hereby expressly incorporated herein by reference in their entirety.

### TECHNICAL FIELD

The present invention relates to a communications system, and more specifically, interconnection of a wireless system to existing wireline communications systems enabling broadband Internet access to residential and business serving wires within local serving areas.

### BACKGROUND

Over several years the telephone operating companies have built their wireline communications systems based on a Bell system engineering practice known as “serving area concept design”, this design's prior art is illustrated in FIG. 1. This design takes a geographic area, associates it to a wire center that is made up of a plurality of serving areas. Each serving area has a set number of homes and businesses to which it can serve. The specific service wire composition, within a serving area is the result of the forecasted construction plans of the land developers and community leaders. From this information the local telephone company lays out the cabling network needed to serve the community, beginning with a primary feeder cable network. The primary feeder cable is like an umbilical cord, extending communications service from the telephone company's central switching office to the wire center. These feeder cables contain large numbers of bundled wire pairs and/or fiber strands in one or more cables. These bundles are then distributed to each serving area within the wire center in smaller bundled pairs sized to meet builder and community leader growth and occupancy forecasts.

As development proceeds, local telephone company transmission equipment is placed in the serving area as part of the feeder/distribution system that joins the feeder cable to the distribution cable network which extends one or more pairs of service wires to each residence or business in a serving area. These residential and business service wires are connected to the feeder/distribution system through a serving area interface cabinet or pedestal. This serving area interface is a hardwire termination point between the residence or business and the telephone company's transmission equipment. The serving area interface cabinet or pedestal typically located adjacent to this transmission equipment along public right-of-way, and is where skilled craft personnel physically place jumper wires that connect residential and business telephone service wires to the telephone company's communications system. It is in this transmission equipment where voice data signals on residential and business service wires are digitized for transmission to and from the telephone company's central office.

It is in the composition of the telephone company's feeder cable network, connecting the wire center to the central office where signal interference resulting from cable length, tightly bundled service wires, the presence of load coils, signal repeaters and fiber optics impede and distort the telephone company's ability to deliver high speed Internet access to many wire centers around the country. The affects on high frequency signal amplitude and phase in the feeder distribution interface restricts residences and businesses from having always-on high speed connections between the customer's premise and the Internet.

What is needed is an alternate communications transport network that overcomes the restrictions of the existing feeder cable network and enables high-speed, low latency transport of high frequency data from a residence or business point of access in the serving area interface to the Internet.

### SUMMARY OF THE INVENTION

A preferred embodiment of the present invention provides an improved communications transport system through the interconnection of a broadband wireless system to the wireline serving area interface of the feeder/distribution system. In particular, a preferred embodiment of the present invention includes a wireless terminal node that is also hardwired in to the serving area interface, using a multi-pair interconnection cable.

In accordance with the present invention, and prior art, twisted copper service pairs from multiple customer premises appear at the serving area interface and are connected directly to a wireless terminal node with the ability to filter low voice band frequencies from the service wire and pass them back through the serving area interface to the telephone company's transmission system. At the same time, take the high data frequencies present on the service wire and send them to the Internet using technology defined with in the embodiment of the present invention and a free space high capacity duplex microwave link.

Through the embodiment of the present invention, a customer's service wire can be connected to the Internet, without the use of the telephone company's transmission system and feeder cable network.

Some preferred embodiments of the present invention include a wireless terminal node that directly connects with other wireless terminal nodes using a network of local microwave radios.

Some preferred embodiments of the present invention include a packet routing capability in the terminal node that enables all terminal nodes within a wire center to transfer data without the assistance of a public Internet connection.

Some preferred embodiments of the present invention include a home or business customer is able to attach a digital subscriber line modem on their service wire and access the Internet without having to place a wireless antenna on or in their home or business.

Some preferred embodiments of the present invention include a communications system comprised of a plurality of remote wireless terminal nodes that contain commercially available passive line frequency filters, a digital line subscriber multiplexer, a compact Internet packet router, and broadband microwave packet radio.

In some preferred embodiments of the present invention a communications system that includes a packet routing function enabling residences and businesses, within as service area to interconnect with residences and businesses associated with wireless terminal nodes in other serving areas and wire centers without the assistance of a public Internet connection.

Some preferred embodiments of the present invention include a voice packet system that enables the residences and businesses associated with a serving area to establish voice connections within and between wire centers, without the assistance of local telephone and public Internet connections.

In some preferred embodiments of the present invention, is the packaging of a low voice (300 Hz-3600 kHz) band filter, cabled to an environmentally hardened digital line subscriber multiplexer used to locally terminate the discrete multi-tone (DMT) line coding from the residential and business service wires with in a service area, and couple them with a compact packet router that interconnects to the public and private Internet over a broadband microwave communications system.

In some preferred embodiments of the present invention, a packet router that applies known administrative applications supporting Internet (PPPOE and bridge encapsulation RFC1483) protocol and routes data to the broadband wireless packet radio for transport to the Internet.

In some preferred embodiments of the present invention, the packet router sends and receives data to and from customer premise equipment and the Internet, between terminal nodes and customer premise equipment located within the communications system.

In some preferred embodiments of the present invention, the communications system includes a plurality of terminal nodes, interconnected to the Internet over a plurality of distribution and transport microwave relays located along public access right of ways within a local geographic service area.

Additional features and advantages of the present invention are readily apparent from the following detailed description of the best mode of carrying out the invention when taken in connection with the accompanying drawings.

### BRIEF DESCRIPTION OF THE DRAWING

FIG. 1 is an overview illustration of the Local Facilities Network Structure found in prior art of the Bell Telephone Local Loop System;

FIG. 2 is an overview illustration of the local broadband wireless access network structure overlay to a pre-existing local facilities network structure in accordance with preferred embodiments of the present invention;

FIG. 3 is block diagram showing a portion of a communications system including a wireless terminal node according to preferred embodiments of the present invention; and

FIG. 4 is a combined block diagram showing the cross connection configuration of a residential or business service wire to the wireless terminal node before telephone lines are interconnected to the telephone company transmission system according to preferred embodiments of the present invention.

### DETAILED DESCRIPTION

Preferred embodiments of the present invention overcome the limitations of the local telephone company's network to deliver broadband Internet access over the feeder cable network of service areas where typical service area concept design rules were applied. The present invention accomplishes this with a unique wireless terminal node that combines both wired and wireless communication capabilities. In some preferred embodiments the terminal node has the capability of bidirectionally exchanging high frequency/high bandwidth signals, both over a microwave wireless link and standard twisted copper pairs found between serving area interfaces. The present invention is not limited to the type of devices connected to twisted copper pairs, or the type of physical structures that may contain such devices.

As described in more detail herein, the wireless terminal node exchanges high throughput digitized data (“broadband”) over a wireless link with another device coupled to the Internet. The wireless terminal node is connected to the residential and business service wires at the serving area interface of the feeder/distribution system serving the physical service area. The terminal node is configured to allow previously existing low frequency signals to be passed between the service wires in the distribution cable with the telephone company's remote transmission equipment, so that the plain old telephone service, “POTS” connection with the telephone company is maintained as before.

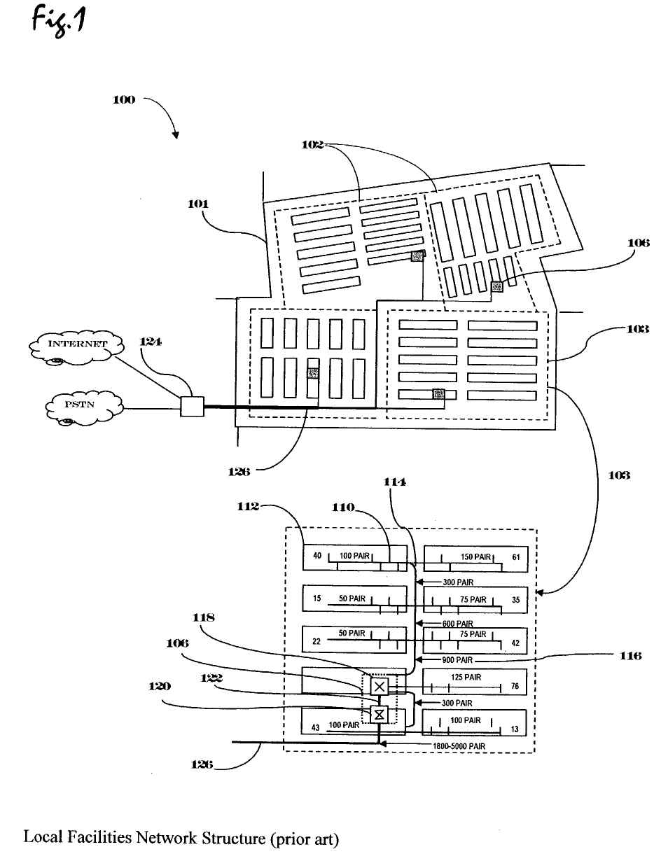

Referring to the prior art of FIG. 1, this is an illustration of a typical local facilities network structure employed by telephone companies using the Bell System serving area concept of communication system design 100. The wireline communications system employs a serving area concept of design that divides geographic wire center boundaries 101 into a plurality of serving areas 102, and where each serving area 102 contains a feeder/distribution system 106. An expansion of a serving area 108 shows that a plurality of residential and business service wires are present within designated development areas 112 in a specific serving area 103. Each residence and business within a development area 112 has service wires 110 extending from their premise to the distribution cable network 114 in the serving area 103. Multiple distribution cables 116 are employed within a serving area 103 and aggregate to a common serving area interface 118 (pedestal/cabinet) of the feeder/distribution system 106. All active residential and business service wires 110 terminate in the serving area interface 118 and are connected to the telephone company's remote transmission equipment 120 via a multi pair splice cable 122 also making up the feeder/distribution system 106. The remote transmission equipment 120 is where the low voice frequencies (300-3400 hz), and in some cases, high data frequencies (20 Khz-16 Ghz) are digitized for transmission to the telephone company's central office 124 using a communications transport system made up of a multi-pair feeder cable network 126.

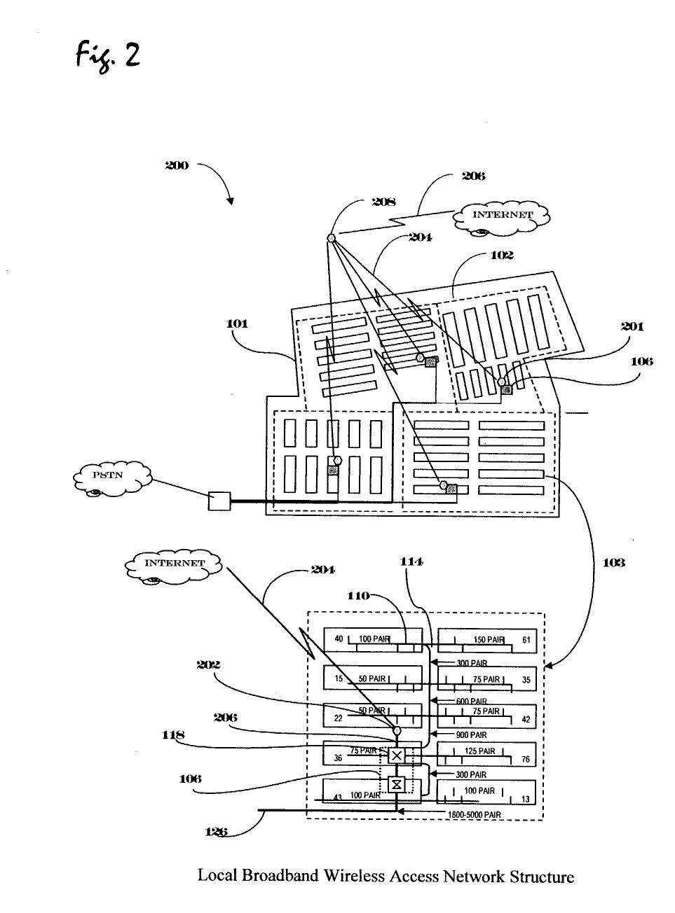

Referring to FIG. 2, this illustration demonstrates one method of delivering broadband wireless to various service areas 102 within a wire center 101. Within each feeder/distribution system 106, a wireless terminal node 201 is connected to the serving area interface 118 through a multi-pair splice cable 206. Each service area 103 targeted for broadband over the distribution network 114 may be equipped with a wireless terminal node 201 to supply broadband Internet access to the service wires 110 of homes and offices within the development area 112. The wireless terminal node may be equipped with a duplex broadband microwave transceiver 202. These transceivers transmit and receive radio signals to and from a microwave aggregation point 208 located outside of the proximity of the wire center. These aggregation points 208 are used to interconnect a wire center to the Internet through a transport backbone 204, and may be deployed in a redundant manner to provide added broadband capacity and route diversity.

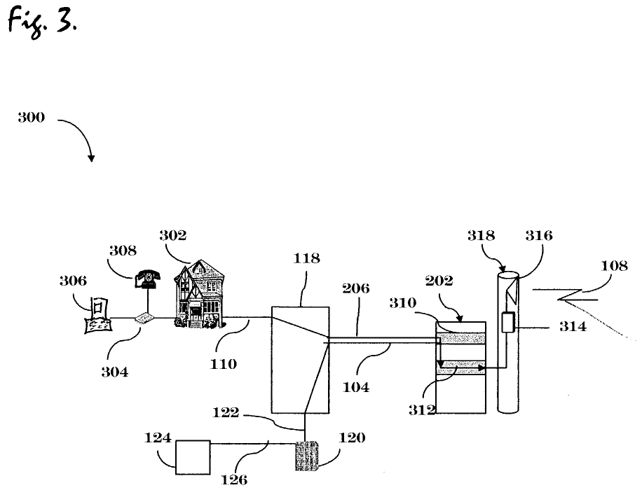

Referring now to FIG. 3, a block diagram showing a portion 300 of the communications system 200 including a terminal node 202 according to preferred embodiments of the present invention. FIG. 3 shows interconnections between the customer premise 302, serving area interface 118 and the terminal node 202. Terminal node 202 includes a metal enclosure (Channell Corporation—Rhino enclosure-R4818AC1S00077), Micro-power system (Hendry 1RU 800 Watts Switch Rectifier 14.7A-OSMF400-2-50; 1RU VDC Power Dist. Panel-OIEGMT70R), passive line filtering device 310 (Coming 192 channel ADSL POTS Splitter-SR192A233-24000), and a DSL multiplexer 312 (ADTRAN TA 3000 1181001L1 and associated ADSL interfaces). Included in some preferred embodiments of the present invention is the Terminal Node Communication Pod 318 (7′ pedestal and high porosity Bell Cap—CN1351), with packet switching system 314 (UT-StarCom/Issanni 500) and a broadband packet radio system (YDI-EX-1 ODU). All components are interconnected using industry standard interfaces.

From the customer premise 302, a DSL modem 304 is connected to the service wire 110 run through out the premise. Both a Personal Computer 306 and telephone 308 is connected to the DSL modem 304 that extend to the wireless terminal node 202 over the service wire 110 connected through the distribution network 114 to the serving area interface 118. From the serving area interface 118 the service wires are connected to the multi-pair cable 206 that extend to the passive line splitters 310 located in the wireless terminal node 202. The line splitter 310 separates the low band voice frequencies (300-3400 Hz) from the high data frequencies (20 KHz-16 GHz) on the home or business service wires 110. Low band frequencies are passed back to the serving area interface 118 over a return pair of the multi-pair cable 206 that terminate to wire pairs that extend over the multi-pair splice cable 122 to the remote transmission equipment 120. Voice calls set up via the telephone 308 will traverse transparently through the wireless terminal node 202 and will connect over the feeder cable network 126 to the telephone company central office 124 to get to the PSTN. The high band data frequencies propagated to and from the customer premise DSL modem 304 to the wireless terminal node over the same wired distribution network 114 as the voice frequencies to the line splitters 310 where high frequencies are diverted to the DSL multiplexer 312 where data is extracted and sent over Cat 5 Ethernet cable to a localized packet router 314 for transmission, over the packet radio 316 located in the communications pod 318 for distribution over the broadband microwave link 204 to a common aggregation point 208 for transport to the Internet.

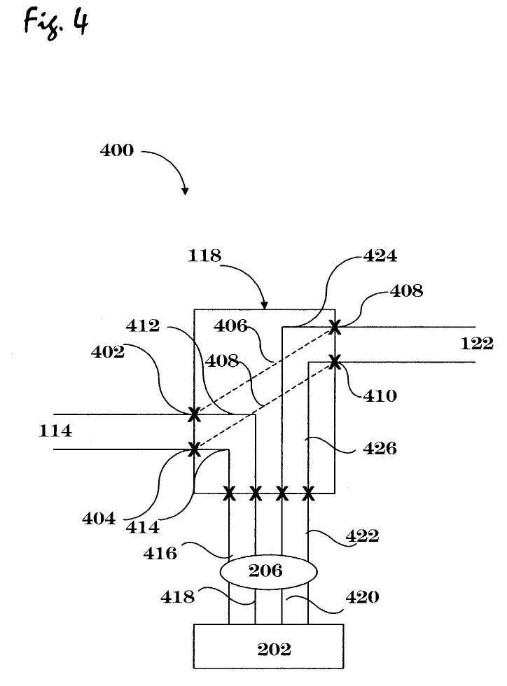

FIG. 4 is a combined block diagram of the wiring configuration in the service access interface 118 cabinet of a communications system 200. This diagram shows the jumper wire configuration of the service wire pairs to the wireless terminal node 202 and the remote transmission equipment 120 making up the feeder/distribution system 106.

The basic hard-wired configuration for standard voice service requires the customer premise service wires 110 enter the service area interface 118 from the distribution network cable 114 and connect directly to the telephone company's remote transmission system 120. The service wires 110 are terminated on the incoming or distribution side of the service area interface 118 on binder pair 402,404. Jumper wires 406,408 are installed by field forces, between 402, 404 and outgoing binder pairs 408,410 of the feeder side of the service area interface 118, physically establishing continuity the home or office to the telephone company's remote transmission system 120 over the multi-pair cable 122.

To enable the local broadband wireless access communications system 200 customer premise service wires 110 enter the service area interface 118 from the distribution network cable 114 and connect directly to the wireless terminal node 202. The service wires 110 are terminated on the incoming or distribution side of the service areas interface 118 on binder pair 402, 404 are installed by field forces, between 402, 404 and outgoing binder pair 416,418 of the interconnection cable 206, physically establishing continuity the home or office to the wireless terminal 202 over the mulit-pair cable 206. Additionally, another pair of jumper wire pairs connected in the service area interface 118 from the wireless terminal binder pair 424,426 from interconnection cable 206, pair 420,422 to the distribution binder pair 408,410 to establish voice frequency continuity to the remote transmission system 120 for connection to the central office 124.

What is claimed is:

1. A hybrid wireline/wireless broadband communications system comprising of: a plurality of terminal nodes, each having access to serving area interface cabinets in the telephone company's serving area and providing broadband access to the existing telephone lines of the homes and offices within these service areas.
a plurality of microwave distribution access and transport relays having at lease one directional antenna forming a directional coverage area, each terminal node communicates with a particular distribution access relay and is connected to the larger microwave transport system to interconnect to the Internet.

2. A broadband communications system as in claim 1 further comprising of a method of interconnecting a wireless terminal node to a serving area interface serving a community of residential and business telephone lines.

3. A broadband communications system as in claim 2 wherein the routing network comprises a distributed network of microwave distribution and transport terminals.

4. A broadband communications system as in claim 3 wherein at least one microwave access relay is in the same serving area as one or more terminal nodes.

5. A broadband communications system as in claim 4 wherein as least one microwave access distribution relay is in communication with the routing network through at least one transport relay antenna.

6. A broadband communication system as in claim 1 for selectively connecting any one of said plurality of customer telephone lines to a microwave distribution system.

7. A broadband communications system as in claim 6 wherein the terminal node further comprises routing capabilities to redirect information packets to and from at least one interface.

8. A broadband communications system as in claim 1 further comprising:
a plurality of terminal nodes interconnected through a distributed microwave system interconnected to the Internet by a transport microwave system.
a plurality of microwave access and distribution relays making up a local broadband communications network that operates with out local telephone company transmission systems.
a plurality of microwave transport relays that link a plurality of distribution networks to the Internet with out least facilities from the local telephone company.

9. A method of distributed management of a hybrid wireless/wireline communications network comprising of:
a plurality of terminal nodes located within a telephone company's service areas.
a plurality of microwave terminal access and distribution relays making up a distributed communications system with no wireline facility.
a local management application that enables a plurality of the communications system elements to automatically provision themselves within the network, manage system performance, operations and auto automatically recover from packet congestion system failure.

10. A hybrid wireline/wireless broadband communications system, comprising:
a terminal node, the terminal node being communicatively coupled to a service area interface and providing broadband communications to telephone lines coupled to the service area interface; and
a wireless broadband network, the wireless broadband network being communicatively coupled to the terminal node and the Internet, the wireless broadband network having the capacity to carry broadband data.

11. The hybrid wireline/wireless broadband communications system of claim 10, wherein the wireless broadband network uses microwave frequencies for communication.

12. The hybrid wireline/wireless broadband communications system of claim 10, wherein the wireless broadband network uses radio frequencies for communication.

13. The hybrid wireline/wireless broadband communications system of claim 10, wherein the wireless broadband network uses millimeter wavelength frequencies for communication.

14. The hybrid wireline/wireless broadband communications system of claim 10, wherein the wireless broadband network uses infrared frequencies for communication.

15. The hybrid wireline/wireless broadband communications system of claim 10, wherein the wireless broadband network uses light for communication.

16. An apparatus for providing telephone line access to the Internet, comprising:
a terminal node, the terminal node being communicatively coupled to at least one telephone line, the terminal node having wireless portion of exchanging data with the Internet and a wired portion for exchanging data over the at least one telephone line.

17. The apparatus for providing telephone line access to the Internet of claim 16, wherein the wireless portion of terminal node further comprises an antenna communicatively coupled through a distributed microwave system to the Internet by a transport microwave system.

18. The apparatus for providing telephone line access to the Internet of claim 17, wherein the wireless portion of terminal node further comprises a plurality of microwave access and distribution relays making up a local broadband communications network that operates without local telephone company transmission systems.

19. A method for providing a customer access to the Internet, comprising;
coupling a terminal node to a portion of the PSTN including a telephone line to the customer, wherein the terminal node has a wireless portion for exchanging data with the Internet and a wired portion for exchanging data over the telephone line; and
providing Internet access to the customer over a telephone line.

20. The method of claim 19 wherein the wireless portion of the terminal node wirelessly exchanges data with the Internet using microwave electromagnetic frequencies propagated through air.

21. The method of claim 19 wherein the telephone line was a previously existing telephone line.

22. The method of claim 19 wherein the telephone line was not a previously existing telephone line.

23. The method of claim 19 wherein data exchanged over the telephone line carries a voice call.

24. The method of claim 19 wherein the terminal node is coupled to the telephone line in a Serving Area Interface.

25. A method for providing a customer access to the Internet, comprising;
coupling a terminal node to a telephone line supporting at least Plain Old Telephone Service (“POTS”), wherein the terminal node has a wireless portion for exchanging data with the Internet and a wired portion for maintaining POTS on the telephone line; and
providing Internet access to the customer over a telephone line.

26. The method for providing a customer access to the Internet of claim 25, further comprising a microwave frequency wireless network for exchanging data between the Internet and the customer.

27. The method for providing a customer access to the Internet of claim 25, wherein a DSL-compatible modem is coupled to the telephone line.

28. A method for providing access to the Internet over a customer telephone line, the customer telephone line being communicatively coupled to the PSTN, comprising;
communicatively severing a link between the customer telephone line and the PSTN; and
communicatively connecting the PSTN and customer telephone line to a terminal node, wherein the terminal node has a wireless portion for facilitating exchanging data with the Internet and a wired portion for communicatively coupling the PSTN and the customer telephone line and for exchanging data over the customer telephone line, the terminal node capable of exchanging data between the wireless portion and wired portion.

29. The method of claim 28 where the link is a cross connect in a Serving Area Interface and the communicatively coupled cross connect is effectively removed from the Serving Area Interface.

30. The method of claim 29 where the terminal node is connected to the PSTN and the customer telephone line in the Serving Area Interface.

31. The method of claim 30 where the terminal node is located adjacent to the Serving Area Interface.

32. A method for providing access to the Internet, comprising;
coupling a terminal node to a portion of the PSTN wherein the terminal node has a wireless portion for exchanging data with the Internet and a wired portion for exchanging data with the PSTN.

33. The method of claim 32 wherein data exchanged with the PSTN carries a voice call.

34. The method of claim 32 wherein data exchanged with the PSTN carries Internet browsing.
